(19) United States
(12) Patent Application Publication
(10) Pub. No.: US 2023/0413067 A1
(43) Pub. Date: Dec. 21, 2023

(54) MULTI-USER PHYSICAL DOWNLINK CONTROL CHANNEL (PDCCH) BEAMFORMING

(71) Applicant: T-MOBILE INNOVATIONS LLC, Overland Park, KS (US)

(72) Inventors: Nagi A. Mansour, Arlington, VA (US); Akin Ozozlu, McLean, VA (US)

(21) Appl. No.: 17/838,408

(22) Filed: Jun. 13, 2022

(51) Int. Cl. H04W 16/28; H04W 72/04; H04J 13/00

(52) U.S. Cl. CPC H04W 16/28; H04J 13/004; H04W 72/046; H04W 72/042

(57) ABSTRACT

Systems and methods are provided for providing multi-user PDCCH beamforming. This enables a single beam to provide coverage to multiple users. Initially, a first signal is communicated by a node configured to wirelessly communicate with one or more UEs to a first UE of the one or more UEs. The first signal includes a first orthogonal code. A second signal is communicated by the node configured to wirelessly communicate with the one or more UEs to a second UE of the one or more UE. The second signal includes a second orthogonal code. Importantly, the first signal and the second signal are communicated by the node via a single beam. By utilizing the orthogonal codes, the node and UEs are able to distinguish and interpret the appropriate signals provided by the single beam.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for multi-user physical downlink control channel (PDCCH) beamforming. More particularly, in aspects set forth herein, systems and methods enable a single PDCCH beam to support more than one user equipment (UE). Initially, a first signal is communicated, by a node configured to wirelessly communicate with one or more UEs, to a first UE of the one or more UEs. The first signal includes a first orthogonal code. A second signal is communicated, by the node configured to wirelessly communicate with the one or more UEs, to a second UE of the one or more UEs. The second signal includes a second orthogonal code. Importantly, the first signal and the second signal are communicated by the node via a single beam.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed;

FIG. 2 illustrates an exemplary PDCCH beamforming engine, in accordance with aspects herein;

FIG. 3 illustrates two UEs supported by a single PDCCH beam, in accordance with aspects herein;

FIG. 4 depicts a flow diagram of a method for multi-user PDCCH beamforming, in accordance with aspects herein;

FIG. 5 depicts a flow diagram of a method for multi-user PDCCH beamforming, in accordance with aspects herein; and

FIG. 6 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 25th Edition (2009).

As used herein, the term “node” is used to refer to network access technology, such as eNode, gNode, etc. In other aspects, the term “node” may be used to refer to one or more antennas being used to communicate with a user device.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, antenna array configuration corresponding to both the access point and the UE, among other factors. The base stations are employed to broadcast and transmit transmissions to user devices of the telecommunications network.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, beamforming is a signal processing technique that enables a node to send targeted beams of data to users. Not only does this reduce interference, it also makes more efficient use of the frequency spectrum. PDCCH beamforming is a type of beamforming that can extend coverage to users using the same amount of energy. By leveraging a narrower beam, PDCCH beamforming can extend coverage to UEs farther away from the node than with traditional beamforming. However, PDCCH beamforming is currently limited to a single UE per beam. In other words, PDCCH beamforming does not currently support utilizing a single beam to provide coverage to more than one user.

The present disclosure is directed to providing multi-user PDCCH beamforming. This enables a single beam to provide coverage to multiple users. To do so, a first signal is communicated by a node configured to wirelessly communicate with one or more UEs to a first UE of the one or more UEs. The first signal include a first orthogonal code. A second signal is communicated by the node configured to wirelessly communicate with the one or more UEs to a second UE of the one or more UE. The second signal includes a second orthogonal code. Importantly, the first signal and the second signal are communicated by the node via a single beam. By utilizing the orthogonal codes, the node and UEs are able to distinguish and interpret the appropriate signals provided by the single beam.

In some aspects, an indication is communicated, by the node, to the first UE and the second UE that the node supports more than one UE via the single beam. Upon receiving a signal from the first UE, the node may interpret the signal communicated by the first UE by multiplying the signal by the first orthogonal code. Similarly, upon receiving a signal from the second UE, the node may interpret the signal communicated by the second UE by multiplying the signal by the second orthogonal code. In some aspects, the first UE and the second UE are in approximately similar direction relative to the node. Additionally, the first UE may be in closer proximity to the node relative to the second UE. Moreover, although aspects referred to herein describe a first UE and a second UE, it should be appreciated that, in some aspects, any number of UEs may be provided coverage by a single PDCCH beam.

Accordingly, a first aspect of the present disclosure is directed to a method for multi-user PDCCH beamforming. The method comprises communicating, by a node configured to wirelessly communicate with one or more UEs, a first signal to a first UE of the one or more UEs. The first signal includes a first orthogonal code. The method also comprises communicating, by the node configured to wirelessly communicate with the one or more UEs, a second signal to a second UE of the one or more UEs. The second signal includes a second orthogonal code. The first signal and the second signal are communicated by the node via a single beam.

A second aspect of the present disclosure is directed to a method for multi-user PDCCH beamforming. The method comprises receiving, from a node configured to wirelessly communicate with one or more UEs, an indication that the node supports more than one UE via a single beam. The method also comprises receiving, at a first UE of the one or more UEs, a first signal comprising a first orthogonal code. The method further comprises receiving, at the first UE of the one or more UEs, a second signal comprising a second orthogonal code. The first signal and the second signal are communicated by the node via the single beam.

Another aspect of the present disclosure is directed to a system for multi-user PDCCH beamforming. The system comprises one or more UEs and a node configured to wirelessly communicate with the one or more UEs. Then node is configured to: 1) communicate a first signal to a first UE of the one or more UEs, the first signal including a first orthogonal code; and 2) communicate a second signal to a second UE of the one or more UEs, the second signal including a second orthogonal code, wherein the first signal and the second signal are communicated by the node via a single beam.

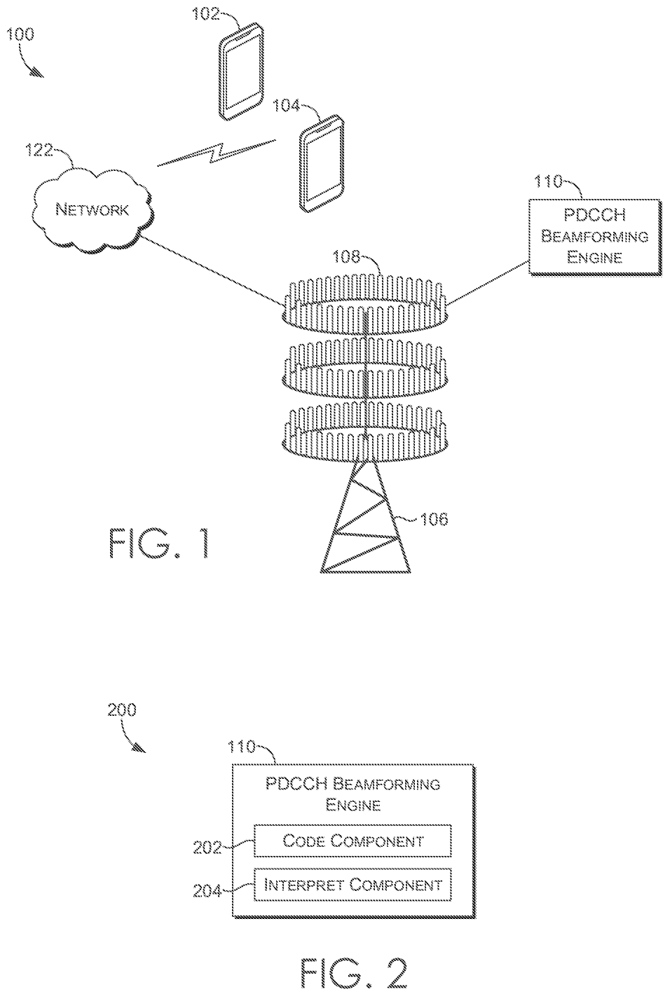

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

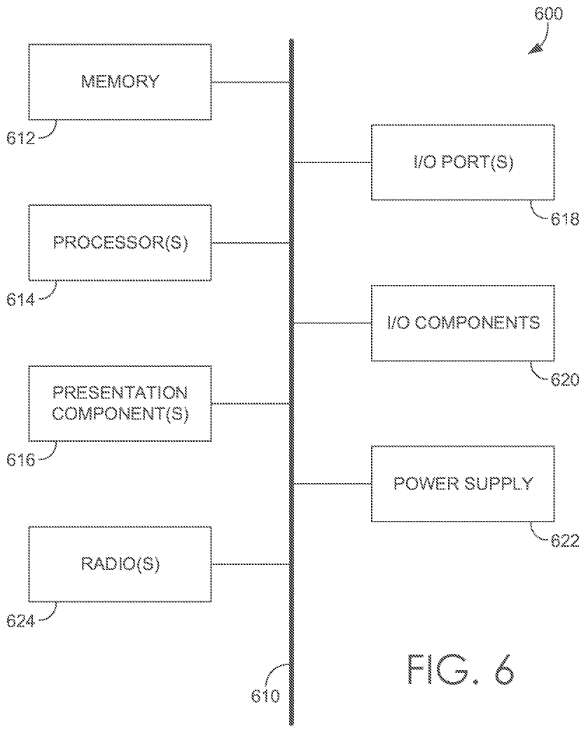

A network cell may comprise a base station to facilitate wireless communication between a communications device within the network cell, such as communications device 600 described with respect to FIG. 6, and a network. As shown in FIG. 1, communications devices may be UEs 102, 104. In the network environment 100, UEs 102, 104 may communicate with other devices, such as mobile devices, servers, etc. The UEs 102, 104 may take on a variety of forms, such as a personal computer, a laptop computer, a tablet, a netbook, a mobile phone, a Smart phone, a personal digital assistant, or any other device capable of communicating with other devices. For example, the UEs 102, 104 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UEs 102, 104 comprise a wireless or mobile device with which a wireless telecommunication network(s) can be utilized for communication (e.g., voice and/or data communication). In this regard, the UEs 102, 104 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

The network environment 100 may include a database (not shown). The database may be similar to the memory component 612 in FIG. 6 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, the UEs 102, 104 may communicate with other devices by using a base station, such as base station 106. In embodiments, base station 106 is a wireless communications station that is installed at a fixed location, such as at a radio tower, as illustrated in FIG. 1. The radio tower may be a tall structure designed to support one or more antennas 108 for telecommunications and/or broadcasting. In other embodiments, base station 106 is a mobile base station. The base station 106 may be an MMU and include gNodeB for mMIMO/5G communications via network 122. In this way, the base station 106 can facilitate wireless communication between UEs 102, 104 and network 122.

As stated, the base station 106 may include a radio (not shown) or a remote radio head (RRH) that generally communicates with one or more antennas associated with the base station 106. In this regard, the radio is used to transmit signals or data to an antenna 108 associated with the base station 106 and receive signals or data from the antenna 108. Communications between the radio and the antenna 108 can occur using any number of physical paths. A physical path, as used herein, refers to a path used for transmitting signals or data. As such, a physical path may be referred to as a radio frequency (RF) path, a coaxial cable path, cable path, or the like.

The antenna 108 is used for telecommunications. Generally, the antenna 108 may be an electrical device that converts electric power into radio waves and converts radio waves into electric power. The antenna 108 is typically positioned at or near the top of the radio tower as illustrated in FIG. 1. Such an installation location, however, is not intended to limit the scope of embodiments of the present invention. The radio associated with the base station 106 may include at least one transceiver configured to receive and transmit signals or data.

Continuing, the network environment 100 may further include a PDCCH beamforming engine 108. The PDCCH beamforming engine 108 may be configured to, among other things, provide multi-user PDCCH beamforming, in accordance with the present disclosure. Though PDCCH beamforming engine 108 is illustrated as a component of base station 106 in FIG. 1, it may be a standalone device (e.g., a server having one or more processors), a component of the UEs 102, 104, a service provided via the network 122, and/or may be remotely located.

Referring now to FIG. 2, the PDCCH beamforming engine 110 may include, among other things, code component 202 and interpret component 204. The PDCCH 110 may receive, among other things, data from user devices, such as UEs 102, 104, within a network cell associated with a particular base station 106, or from the base station 106 itself. For example, the PDCCH beamforming engine 110 may receive a signal from UE(s) 102, 104 to the base station 106 or a signal from the base station 106 to the UE(s) 102, 104.

The code component 202 generates an orthogonal code that is communicated as part of the signal from the UE(s) 102, 104 to the base station 106 or vice versa. The orthogonal code enables the UE(s) 102, 104 to determine if the signal from the base station 106 was intended for UE 102 or UE 104. Similarly, the orthogonal code enables the base station 106 to determine if the signal was communicated by UE 102 or UE 104.

The interpret component 204 utilizes the orthogonal code to interpret the signal. For example, assume the signal was communicated by the base station 106 to UE 104. If the interpret component 204 utilizes the orthogonal code corresponding to UE 102 to interpret the signal, the result is zero and UE 102 understands the signal was not intended for UE 102. If however, the interpret component 204 utilizes the orthogonal code corresponding to UE 104 to interpret the signal, the result is the signal itself and UE 104 understands the signal was intended for UE 104. Moreover, UE 104 is able to interpret the signal itself.

Similarly, assume the signal was communicated by UE 102 to the base station 106. If the interpret component 204 utilizes the orthogonal code corresponding to UE 104 to interpret the signal, the result is zero and the base station 106 understands the signal was not communicated by UE 104. If however, the interpret component 204 utilizes the orthogonal code corresponding to UE 102 to interpret the signal, the result is the signal itself and the base station 106 understands the signal was communicated by UE 102. Moreover, the base station 106 is able to interpret the signal itself.

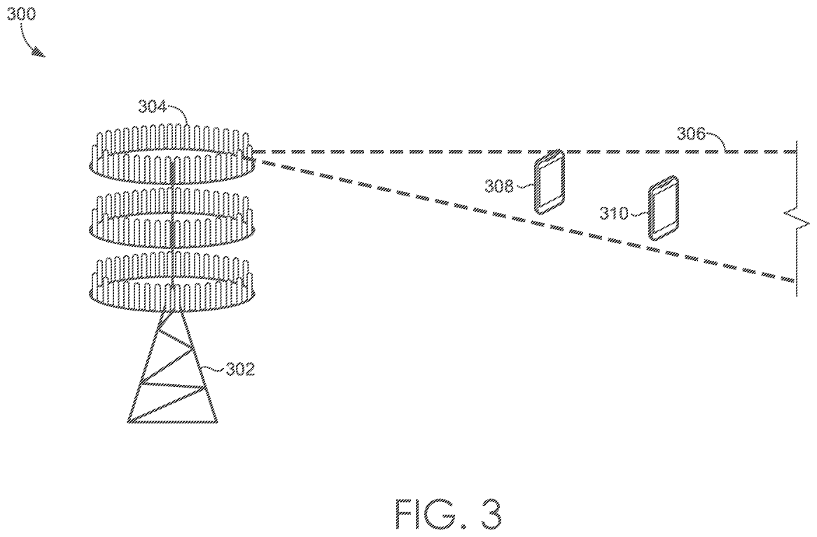

Turning to FIG. 3, a diagram 300 is provided depicting two UEs supported by a single PDCCH beam, according to aspects of the technology described herein. As illustrated, the UEs 308, 310 may communicate with other devices by using a base station, such as base station 302. In embodiments, base station 302 is a wireless communications station that supports one or more antennas 304 for telecommunications and/or broadcasting. The base station 302 may be an MMU and include gNodeB for mMIMO/5G communications via network. In this way, the base station 302 can facilitate wireless communication between UEs 308, 310 and network.

More particularly, the base station 302 may employ a single PDCCH beam 306 to provide service to UEs 308, 310. As illustrated, in some aspects, UE 308 and UE 310 are in an approximately similar direction relative to the base station 302. Also as illustrated, in some aspects, UE 308 is in close proximity to the base station 302 and UE 310 is in extended proximity to the base station 302. Put another way, UE 308 is closer to the base station 302 than UE 310. By utilizing orthogonal codes, as explained in more detail herein, UE 308 and UE 310 are able to determine which signal communicated by the base station 302 is intended for which UE and is further able to interpret the signal that is intended for itself. Additionally, the base station 302 is able to determine which signal is communicated by which UE and is further able to interpret the signal itself.

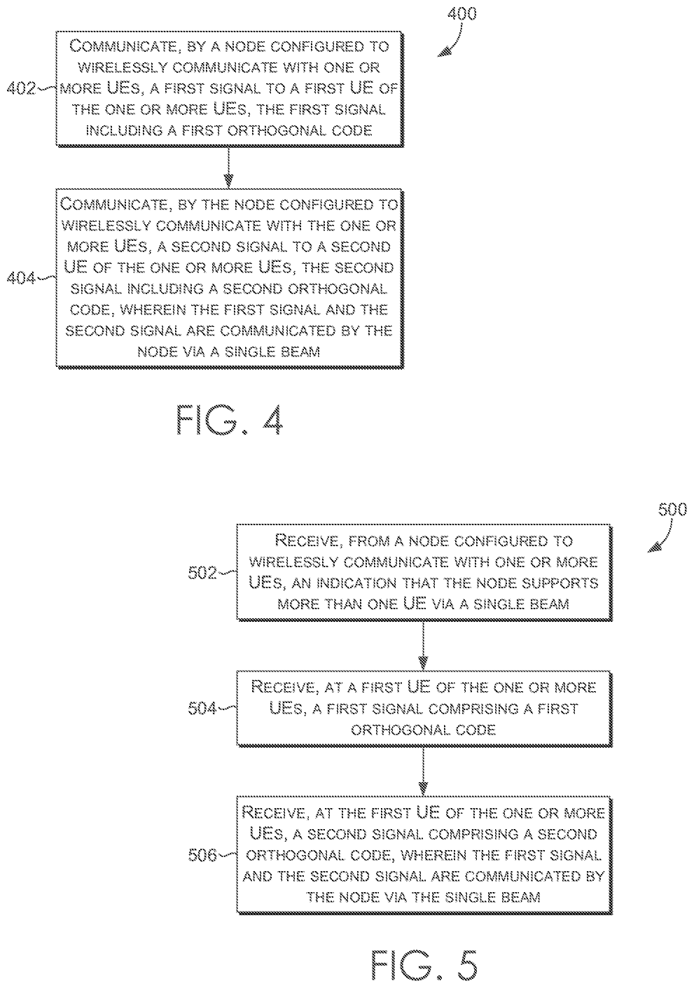

Referring to FIG. 4, a flow diagram is provided depicting a method 400 for multi-user PDCCH beamforming, in accordance with aspects of the present invention. Method 400 may be performed by any computing device (such as computing device described with respect to FIG. 6) with access to a PDCCH beamforming engine (such as the one described with respect to FIG. 2) or by one or more components of the network environment described with respect to FIG. 1 (such as UE 102, 104, base station 106, or PDCCH beamforming engine 110).

Initially, at step 402, a first signal is communicated, by a node configured to wirelessly communicate with one or more UEs, to a first UE of the one or more UEs. The first signal includes a first orthogonal code. For example, for illustrative purposes, the first signal may be denoted by S1*C1 with the interpretable communication from the first UE denoted by S1 and the first orthogonal code denoted by C1.

At step 404, a second signal is communicated, by the node configured to wirelessly communicate with the one or more UEs, to a second UE of the one or more UEs. The second signal includes a second orthogonal code. Continuing the example, for illustrative purposes, the second signal may be denoted by S2*C2 with the interpretable communication from the second UE denoted by S2 the second orthogonal code denoted by C2. Importantly, the first signal and the second signal are communicated by the node via a single beam.

In aspects, the node communicates an indication to the first UE and the second UE that the node supports more than one UE via the single beam. Upon the indication being communicated, in some aspects, the UE may generate and communicate an orthogonal code to the node. Alternatively, the node may generate and communicate the orthogonal code to the UE. In each aspect, the UE and the node are able to utilize the orthogonal code to interpret communications between the UE and the node.

For example, a first signal S1*C1 may be received from the first UE at the node and a second signal S2*C2 may be received from the second UE at the node. The node may interpret the signal communicated by the first UE by multiplying the first signal S1*C1 by the first orthogonal code C1. The result will be S1 and the communication can be interpreted. Similarly, the node may interpret the signal communicated by the second UE by multiplying the second signal S2*C2 by the second orthogonal code C2. The result will be S2 and the communication can be interpreted.

In contrast, if the node attempts to interpret the second signal S2 from the second UE using the first orthogonal code C1 (by multiplying the second signal S2 by the first orthogonal code C1), the result will be zero and the node will be unable to interpret the second signal. Similarly, if the node attempts to interpret the first signal S1 from the first UE using the second orthogonal code C2 (by multiplying the first signal S1 by the second orthogonal code C2), the result will be zero and the node will be unable to interpret the first signal.

In aspects, the first UE and the second UE are in an approximately similar direction relative to the node. In this way, a single beam from the node enables the node to communicate with both the first UE and the second UE. In some aspects, the first UE is in closer proximity to the node relative to the second UE, or vice versa. In other aspects, the first UE and the second UE are in similar proximity relative to the node.

In FIG. 5, a flow diagram is provided depicting a method 500 for multi-user PDCCH beamforming, in accordance with aspects of the present invention. Method 500 may be performed by any computing device (such as computing device described with respect to FIG. 6) with access to a PDCCH beamforming engine (such as the one described with respect to FIG. 2) or by one or more components of the network environment described with respect to FIG. 1 (such as UE 102, 104, base station 106, or PDCCH beamforming engine 110).

Initially, at step 502, an indication that the node supports more than one UE via a single beam is received from a node configured to wirelessly communicate with one or more UEs. The indication may cause a first UE of the one or more UEs attempting to communicate with the node to generate and communicate a first orthogonal code to the node. Alternatively, upon receiving an indication from the first UE of the one or more UEs that the UE is attempting to communicate with the node, the node may generate and communicate a first orthogonal code to the node. The orthogonal codes enable the node to distinguish and interpret signals from the first UE and the second UE as well as enabling the first UE and the second UE to distinguish and interpret the appropriate signals communicated by the node.

At step 504, a first signal comprising a first orthogonal code may be received at the first UE of the one or more UEs. For example, for illustrative purposes, the first signal may be denoted by S1*C1 with the interpretable communication from the node to the first UE denoted by S1 and the first orthogonal code denoted by C1.

At step 506, because the node is supporting more than one UE via a single beam, a second signal comprising a second orthogonal code may be received by the first UE from the node. In some aspects, a second UE of the one or more UEs also receives the first signal comprising the first orthogonal code and the second signal comprising the second orthogonal code from the node. Continuing the example, for illustrative purposes, the second signal may be denoted by S2*C2 with the interpretable communication from the node to the second UE denoted by S2 the second orthogonal code denoted by C2.

In some aspects, the first UE may communicate a signal to the node. A third signal S3 comprising a first orthogonal code may be communicated to the node. The node may utilize the first orthogonal code to determine the signal S3 was communicate by the first UE by multiplying the signal S3 by the first orthogonal code. If the result is S3, the signal was communicated by the first UE and the node is able to interpret the signal. If on the other hand the result is zero, the signal was not communicated by the first UE and the node may attempt to interpret the signal using orthogonal codes from other UEs.

By way of example, assume a node is using a single beam to communicate with a first UE and a second UE. Because the first UE and the second UE are being supported by a single beam from the node, a first signal S1*C1 may be received by the first UE and the second UE from the node and a second signal S2*C2 may also be received by the first UE and the second UE from the node. The first UE may interpret the first signal communicated by the node by multiplying the first signal S1*C1 by the first orthogonal code C1. The result will be S1 and the communication can determined by the first UE that it was intended for the first UE. Moreover, the communicated can be interpreted by the first UE. Similarly, the second UE may interpret the second signal communicated by the node by multiplying the second signal S2*C2 by the second orthogonal code C2. The result will be S2 and the communication can determined by the second UE that it was intended for the second UE. Moreover, the communicated can be interpreted by the second UE.

In contrast, if the first UE attempts to interpret the second signal S2 from the node using the first orthogonal code C1 (by multiplying the second signal S2 by the first orthogonal code C1), the result will be zero and the first UE will be unable to interpret the second signal. Similarly, if the second UE attempts to interpret the first signal S1 from the node using the second orthogonal code C2 (by multiplying the first signal S1 by the second orthogonal code C2), the result will be zero and the second UE will be unable to interpret the first signal.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for multi-user physical downlink control channel (PDCCH) beamforming, the method comprising:
communicating, by a node configured to wirelessly communicate with one or more UEs, a first signal to a first UE of the one or more UEs, the first signal including a first orthogonal code; and
communicating, by the node configured to wirelessly communicate with the one or more UEs, a second signal to a second UE of the one or more UEs, the second signal including a second orthogonal code, wherein the first signal and the second signal are communicated by the node via a single beam.

2. The method of claim 1, further comprising communicating, by the node, an indication to the first UE and the second UE that the node supports more than one UE via the single beam.

3. The method of claim 1, further comprising, receiving, at the node, a signal from the first UE.

4. The method of claim 3, further comprising interpreting, at the node, the signal communicated by the first UE by multiplying the signal by the first orthogonal code.

5. The method of claim 1, further comprising, receiving, at the node, a signal from the second UE.

6. The method of claim 5, further comprising interpreting, at the node, the signal communicated by the second UE by multiplying the signal by the second orthogonal code.

7. The method of claim 1, wherein the first UE and the second UE are in an approximately similar direction relative to the node.

8. The method of claim 7, wherein the first UE is in closer proximity to the node relative to the second UE.

9. A method for multi-user physical downlink control channel (PDCCH) beamforming, the method comprising:
receiving, from a node configured to wirelessly communicate with one or more UEs, an indication that the node supports more than one UE via a single beam;
receiving, at a first UE of the one or more UEs, a first signal comprising a first orthogonal code; and
receiving, at the first UE of the one or more UEs, a second signal comprising a second orthogonal code, wherein the first signal and the second signal are communicated by the node via the single beam.

10. The method of claim 9, further comprising determining, at the first UE which of the first signal or the second signal was intended for the first UE.

11. The method of claim 10, wherein the determining comprises:
multiplying the first signal by the first orthogonal code; and
upon determining the result is not zero, determining the first signal was intended for the first UE.

12. The method of claim 10, wherein the determining comprises:
multiplying the first signal by the second orthogonal code; and
upon determining the result is zero, determining the first signal was not intended for the first UE.

13. The method of claim 10, wherein the determining comprises:
multiplying the second signal by the second orthogonal code; and
upon determining the result is not zero, determining the second signal was intended for the first UE.

14. The method of claim 10, wherein the determining comprises:
multiplying the second signal by the first orthogonal code; and
upon determining the result is zero, determining the second signal was not intended for the first UE.

15. The method of claim 9, further comprising communicated, to the node, a third signal from the first UE comprising the first orthogonal code.

16. The method of claim 9, wherein the first UE generates the first orthogonal code and communicates the first orthogonal code to the node.

17. The method of claim 9, wherein the node generates the first orthogonal code and communicates the first orthogonal code to the first UE.

18. A system for multi-user physical downlink control channel (PDCCH) beamforming, the system comprising:
one or more UEs; and
a node configured to wirelessly communicate with the one or more UEs, wherein the node is configured to:
(1) communicate a first signal to a first UE of the one or more UEs, the first signal including a first orthogonal code; and
(2) communicate a second signal to a second UE of the one or more UEs, the second signal including a second orthogonal code, wherein the first signal and the second signal are communicated by the node via a single beam.

19. The system of claim 18, further comprising:
receiving, at the node, a signal from the first UE; and
interpreting, at the node, the signal communicated by the first UE by multiplying the signal by the first orthogonal code.

20. The system of claim 18, further comprising:
receiving, at the node, a signal from the second UE; and
interpreting, at the node, the signal communicated by the second UE by multiplying the signal by the second orthogonal code.
